(19) United States
(12) Patent Application Publication
(10) Pub. No.: US 2009/0194990 A1
(43) Pub. Date: Aug. 6, 2009

(54) TOOTHED GRIPPER MEMBERS, PLUMBING CONNECTION ASSEMBLIES AND METHODS FOR FORMING THE SAME

(76) Inventor: Robert M. Williams, Longboat Key, FL (US)

Correspondence Address: MYERS BIGEL SIBLEY & SAJOVEC, PO BOX 37428, RALEIGH, NC, 27627, US

(21) Appl. No.: 12/026,015

(22) Filed: Feb. 5, 2008

(51) Int. Cl. F16L 55/00

(52) U.S. Cl. 285/23

(57) ABSTRACT

A gripper member for forming a mechanical connection with tubing includes an annular ring body and a plurality of teeth extending from the ring body. Each tooth has a tooth length and a fixed end and an opposed free end spaced apart along the tooth length, wherein the fixed end adjoins the ring body. The teeth are angled radially inwardly from the ring body such that the free ends define an inner engagement circumference to receive the tubing. Each tooth has a substantially creased lengthwise bend therein extending to the free end thereof.

### FIELD OF THE INVENTION

The present application relates to plumbing components and, more particularly, to plumbing connections and mechanisms for securing plumbing components to tubing.

### BACKGROUND OF THE INVENTION

Gripper or retainer rings are commonly employed to mechanically couple tubing to plumbing fittings and the like. Known gripper rings include an annular ring body having a plurality of integral, circumferentially spaced apart teeth that are cantilevered from the ring body and angled radially inwardly. In use, the tubing is inserted through the ring body and the teeth such that, upon attempted withdrawal of the tubing from the gripper ring, the teeth bite into the outer surface of the tubing to resist such withdrawal.

### SUMMARY OF THE INVENTION

According to embodiments of the present invention, a gripper member for forming a mechanical connection with tubing includes an annular ring body and a plurality of teeth extending from the ring body. Each tooth has a tooth length and a fixed end and an opposed free end spaced apart along the tooth length, wherein the fixed end adjoins the ring body. The teeth are angled radially inwardly from the ring body such that the free ends define an inner engagement circumference to receive the tubing. Each tooth has a substantially creased lengthwise bend therein extending to the free end thereof.

According to some embodiments, each tooth has a terminal edge on its free end, and each tooth is configured such that, when the tubing is inserted through the inner engagement circumference, at least one discrete portion of the tooth's terminal edge engages and bites into the tubing to a substantially greater extent than at least one remaining portion of the tooth's terminal edge.

According to some embodiments, the terminal edge of each tooth has a V-shaped profile. According to some embodiments, the outer points of the V-shaped profiles of the teeth define the inner engagement circumference and bite into the tubing when the tubing is inserted through the inner engagement circumference. According to some embodiments, the apex points of the V-shaped profiles of the teeth define the inner engagement circumference and bite into the tubing when the tubing is inserted through the inner engagement circumference. The bend axis is substantially orthogonal to the terminal edge plane.

According to some embodiments, the terminal edge of each tooth defines a terminal edge plane and substantially all of the terminal edge lies in the terminal edge plane. According to some embodiments, the lengthwise bend of each tooth extends along a bend axis and the terminal edge plane is substantially perpendicular to the bend axis.

According to embodiments of the present invention, a plumbing connection assembly for forming a connection with tubing includes a plumbing component body and a gripper member mounted on the plumbing component body to engage the tubing and mechanically secure the tubing to the plumbing component body. The gripper member includes an annular ring body and a plurality of teeth extending from the ring body. Each tooth has a tooth length and a fixed end and an opposed free end spaced apart along the tooth length, wherein the fixed end adjoins the ring body. The teeth are angled radially inwardly from the ring body such that the free ends define an inner engagement circumference to receive the tubing. Each tooth has a substantially creased lengthwise bend therein extending to the free end thereof.

According to some embodiments, the assembly includes an adapter for forming a connection between a non-solvent weldable tubing and a solvent weldable member, wherein the plumbing component body is solvent weldable and the assembly further includes a resilient seal member configured to engage and form a fluid-tight seal between the non-solvent weldable tubing and the plumbing component body.

According to embodiments of the present invention, a method for forming a gripper member adapted to form a mechanical connection with tubing includes: forming an annular ring body; forming a plurality of teeth extending from the ring body, wherein each tooth has a tooth length and a fixed end and an opposed free end spaced apart along the tooth length, wherein the fixed end adjoins the ring body; angling the teeth radially inwardly from the ring body such that the free ends define an inner engagement circumference to receive the tubing; and bending each tooth to form in the tooth a substantially creased lengthwise bend extending to the free end thereof.

According to embodiments of the present invention, a gripper member for forming a mechanical connection with tubing includes an annular ring body and a plurality of teeth extending from the ring body. Each tooth has a tooth length and a fixed end and an opposed free end spaced apart along the tooth length, wherein the fixed end adjoins the ring body and a terminal edge is located on the free end. The teeth are angled radially inwardly from the ring body such that the free ends define an inner engagement circumference to receive the tubing. Each tooth has a lengthwise bend therein. Each tooth is configured such that, when the tubing is inserted into the inner engagement circumference, at least one discrete portion of the tooth's terminal edge engages and bites into the tubing to a substantially greater extent than at least one remaining portion of the tooth's terminal edge.

According to embodiments of the present invention, a plumbing connection assembly for forming a connection with tubing includes a plumbing component body and a gripper member mounted on the plumbing component body to engage the tubing and mechanically secure the tubing to the plumbing component body. The gripper member includes an annular ring body and a plurality of teeth extending from the ring body. Each tooth has a tooth length and a fixed end and an opposed free end spaced apart along the tooth length, wherein the fixed end adjoins the ring body and a terminal edge is located on the free end. The teeth are angled radially inwardly from the ring body such that the free ends define an inner engagement circumference to receive the tubing. Each tooth has a lengthwise bend therein. Each tooth is configured such that, when the tubing is inserted into the inner engagement circumference, at least one discrete portion of the tooth's terminal edge engages and bites into the tubing to a substantially greater extent than at least one remaining portion of the tooth's terminal edge.

According to some embodiments, the assembly includes an adapter for forming a connection between a non-solvent weldable tubing and a solvent weldable member, wherein the plumbing component body is solvent weldable and the assembly further includes a resilient seal member configured to engage and form a fluid-tight seal between the non-solvent weldable tubing and the plumbing component body.

According to embodiments of the present invention, a method for forming a gripper member adapted to form a mechanical connection with tubing includes: forming an annular ring body; forming a plurality of teeth extending from the ring body, wherein each tooth has a tooth length and a fixed end and an opposed free end spaced apart along the tooth length, wherein the fixed end adjoins the ring body and a terminal edge is located on the free end; angling the teeth radially inwardly from the ring body such that the free ends define an inner engagement circumference to receive the tubing; bending each tooth to form in the tooth a lengthwise bend; and configuring each tooth such that, when the tubing is inserted into the inner engagement circumference, at least one discrete portion of the tooth's terminal edge engages and bites into the tubing to a substantially greater extent than at least one remaining portion of the tooth's terminal edge.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a perspective view of a gripper member according to embodiments of the present invention.

FIG. 2 is a top plan view of the gripper member of FIG. 1.

FIG. 3 is a cross-sectional view of the gripper member of FIG. 1 taken along the line 3-3 of FIG. 2.

FIG. 4 is an enlarged, cross-sectional view of the gripper member of FIG. 1 from the detail 4-4 of FIG. 3.

FIG. 5 is an enlarged, fragmentary perspective view of the gripper member of FIG. 1.

FIG. 6 is a perspective view of a gripper member according to further embodiments of the present invention.

FIG. 7 is a perspective view of an adapter according to embodiments of the present invention including the gripper member of FIG. 1.

FIG. 8 is an exploded perspective view of the adapter of FIG. 7.

FIG. 9 is a cross-sectional view of the adapter of FIG. 7 taken along the line 9-9 of FIG. 7.

FIG. 10 is a cross-sectional view of a tubing assembly according to embodiments of the present invention including the adapter of FIG. 7 mounted on a non-solvent weldable tubing.

FIG. 11 is a perspective view of a connection assembly according to embodiments of the present invention and including the adapter of FIG. 7.

FIG. 12 is a perspective, cross-sectional view of the connection assembly of FIG. 11.

FIG. 13 is a partially exploded, perspective view of a plumbing connection assembly according to further embodiments of the present invention including the gripper member of FIG. 1.

FIG. 14 is a fragmentary, cross-sectional view of the plumbing connection assembly of FIG. 13.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

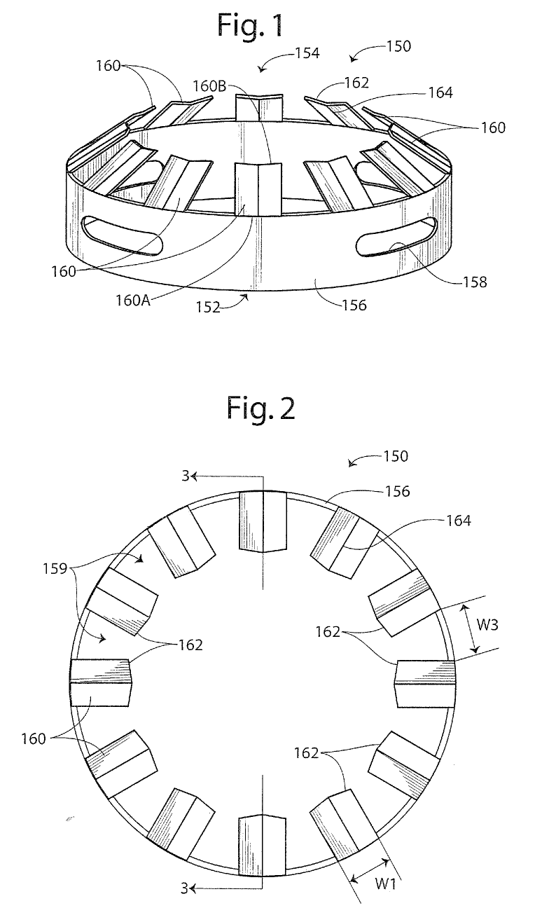

With reference to FIGS. 1-5, a gripper member 150 according to embodiments of the present invention is shown therein. According to some embodiments, the gripper member 150 is used to effectively and operatively mechanically engage and secure tubing (e.g., tubing 20 as discussed and illustrated herein).

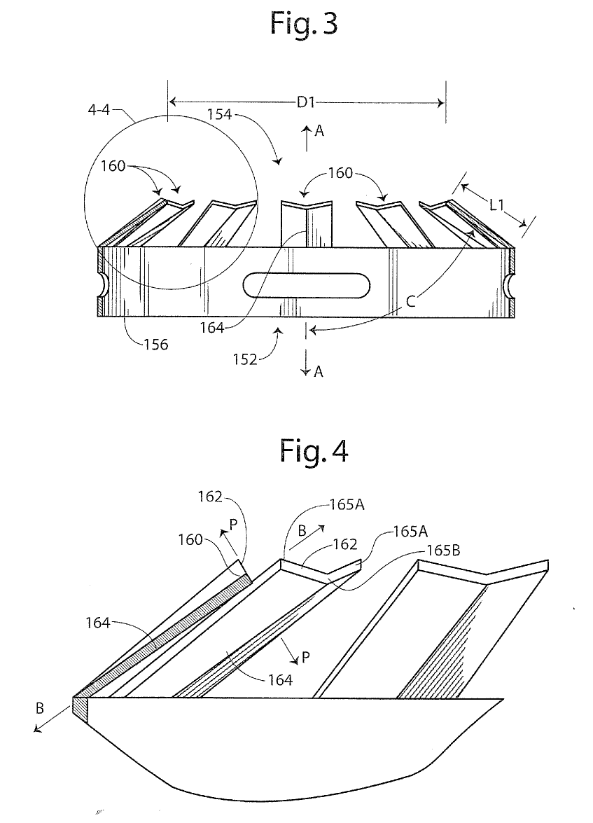

The gripper member 150 has an entrance opening 152 and an exit opening 154. The gripper member 150 includes a collar, body or base section 156 and a plurality of integral teeth 160 deflectably cantilevered from the exit edge of the base section 156. Each tooth 160 has a fixed or pivot end 160A adjoined to the base section 156 and an opposed bite or free end 160B spaced apart from the pivot end 160A along the length L1 (FIG. 3) of the tooth 160. A terminal edge 162 is located on each free end 160B. As discussed in more detail below, each tooth 160 has a lengthwise bend 164 formed therein. The teeth 160 define slots 159 therebetween. The teeth 160 are angled radially inwardly and collectively tapered to define a frusto-cone. The free ends 160B of the teeth 160 define the exit opening 154, which serves as an inner engagement circumference having a reduced diameter D1 at the exit end of the gripper member 150. The gripper member 150 defines a central insertion axis A-A (FIG. 3). Four circumferentially spaced apart mounting slots 158 are defined in the base section 156.

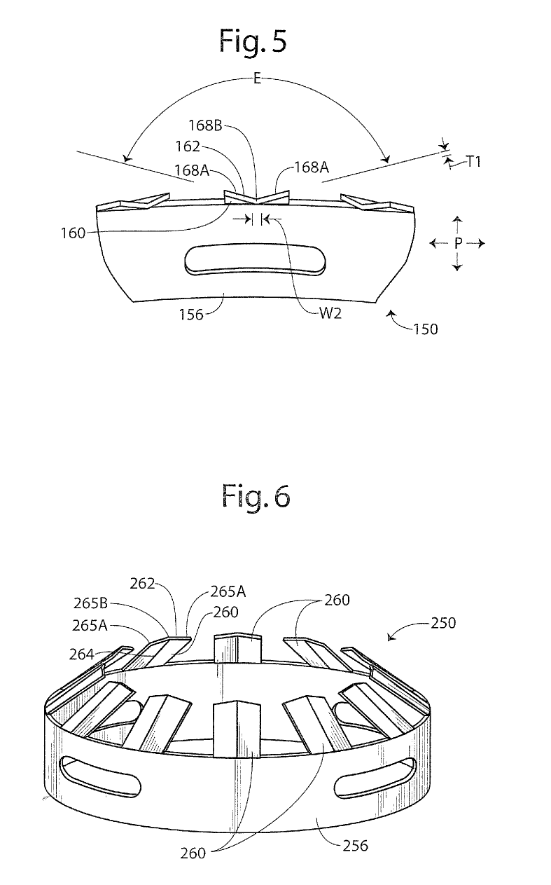

Each tooth 160 has a bend 164 extending along its length from the pivot end 160A to the free end 160B along a bend axis B-B (FIG. 4). According to some embodiments, the bend 164 is a substantially creased bend, as opposed to a smooth arcuate bend extending across the full width of the tooth 160. According to some embodiments, the bend 164 only extends across a portion of the width of the tooth 160 so that the tooth 160 comprises three portions or segments, namely, the bent portion 168B and the two flat or unbent side portions or panels 168A located on either side of the bent portion 168B (FIG. 5).

As a result of the bend 164, the terminal edge 162 of each tooth 160 has a substantially V-shaped profile. The V-shaped profile is oriented such that the apex of the “V” is positioned radially inward relative to the outer ends of the “V”. An apex section or point 165B (FIG. 4) of the tooth 160 is thus located radially inwardly of outer end sections or points 165A of the tooth 160. The apex sections 165B collectively define the inner engagement circumference of the gripper member 150.

According to some embodiments, the angle E (FIG. 5) of the bend 164 portion 168B is between about 130 and 170 degrees. According to some embodiments, the angle E is between about 140 and 160 degrees.

According to some embodiments, the width W2 (FIG. 5) of the bent portion 168B is no more than 30 percent of the width W1 (FIG. 2) of the tooth 160. According to some embodiments, the width W2 is between about 20 and 30 percent of the width W1.

According to some embodiments and as shown, the bend 164 equilaterally bisects the tooth 160. According to some embodiments and as shown, the angle of the bend 164 progressively increases from the pivot end 160A to the free end 160B so that a steeper angle is formed in the tooth 160 closer to the free end 160B.

According to some embodiments and as shown, the terminal edge 162 of each tooth lies substantially entirely in a plane P-P (FIGS. 4 and 5). According to some embodiments, the plane P-P is disposed at an angle with respect to the central axis A-A of between zero and 90 degrees. According to some embodiments and as shown, the bend axis B-B is substantially orthogonal to the plane P-P.

The gripper member 150 may be integrally formed of any suitable strong, flexible, resilient material. According to some embodiments, the gripper member 150 is formed of a corrosion resistant material. According to some embodiments, the gripper member 150 is formed from metal and, according to some embodiments, a corrosion resistant metal. According to some embodiments, the gripper member 150 is formed of stainless steel.

According to some embodiments, the gripper member 150 is stamped from metal. The bends 164 may be formed concurrently with the formation of the base section 156 and teeth 160 (e.g., during a stamping step), or may be formed in a subsequent step.

According to some embodiments, the base section 156 and the teeth 160 have a thickness T1 (FIG. 5) in the range of from about 0010 to 0.020 inch.

According to some embodiments, the inner diameter D1 (FIG. 3) defined by the free ends 160B (prior to installation of the tubing 20) is less than the outer diameter of the tubing with which the gripper member 150 is intended for use. According to some embodiments, the diameter D1 is from about 0.010 to 0.025 less than the outer diameter of the tubing. According to some embodiments, the diameter D1 is in the range of from about 0.600 to 0.615 inch.

According to some embodiments, the teeth 160 have a length L1 (FIG. 3) in the range of from about 0.140 to 0.150 inch. According to some embodiments, the width W1 (FIG. 2) of each tooth 160 is in the range of from about 0.09 to 0.10 inch. According to some embodiments, the spacing width W3 (FIG. 2) between adjacent teeth 160 is in the range of from about 0.12 to 0.13 inch.

According to some embodiments, each tooth 160 extends (prior to installation of the tubing 20) at an angle C (FIG. 3) of between about 27 and 33 degrees with respect to the central axis A-A.

In use, the gripper member 150 may be mounted on a plumbing component member or body (e.g., on-site or preassembled in a factory). Tubing may be mechanically secured to the plumbing component by inserting the tubing through the gripper member 150 along the insertion axis A-A in the direction from the entrance opening 152 to the exit opening 154. The tubing may radially outwardly deflect the teeth 160 as it is inserted. When the tubing is partially withdrawn, the gripper member 150 will form a mechanical interlock with the tubing. More particularly, the teeth 160 engage the outer surface of the tubing at an angle with respect to the axis of the tubing such that attempted withdrawal of the tubing causes the teeth 160 to cut, dig, embed or bite into or wedge against the tubing outer surface. The interlock may serve to permanently prevent withdrawal of the tubing from the gripper member 150 in the reverse direction beyond a prescribed amount.

The interlock between the gripper member 150 and the tubing may be enhanced by the geometrical configuration of the teeth 160 and, in particular, the provision of the-lengthwise bends 164. The apex sections 165B are presented to the peripheral surface of the tubing as sharp corners or point locations that preferentially engage the tubing as compared to the remaining portions of the terminal edges 162, which are radially more distant from the tubing. The apex sections 165B thereby bite into the tubing at spaced apart locations. More particularly, the apex section 165B of each tooth 160 is a discrete portion of the tooth 160 that bites into the tubing to a substantially greater extent than remaining portions of the tooth (e.g., the outer sections 165A). In this way, the teeth 160 prevent or inhibit rotation of the tubing about the central axis A-A. So-called “ringing” of the tubing outer surface by the teeth 160 can thereby be prevented. The configuration of the teeth 160 may also provide a more robust and reliable interlock with the tubing by enabling the apex sections 165B to embed more deeply into the tubing than would be the case with teeth not having such projecting sections (i.e., the apex sections 165B), thereby better preventing or inhibiting axial withdrawal of the tubing.

The lengthwise bends 164 may serve to increase the stiffness and strength of the teeth 160. The bend 164 of each tooth 160 may resist lateral bending or flexure of the tooth 160 along its length, so that any bending occurs predominantly or substantially entirely at the pivot end 160A of the tooth 160. The geometrical configuration of the teeth 160 can therefore permit the use of a thinner and/or more flexible material for the gripper member 150.

According to some embodiments, the apex sections 165B are spaced apart equidistantly about the circumference of the inner engagement circumference 154.

The gripper member 150 may be used to engage and secure any suitable type or construction of tubing. Such tubing may include flexible, rigid or semi-rigid tubing. The tubing may be formed of a metal or polymeric material, and may be a composite (i.e., multi-layer) tubing. According to some embodiments, the tubing is formed of a high temperature polyolefin. According to some embodiments, the tubing is formed of polybutylene, polyethylene, PEX, and/or polyethylene-raised temperature (PE-RT). According to some embodiments, the tubing is formed of PVC or CPVC.

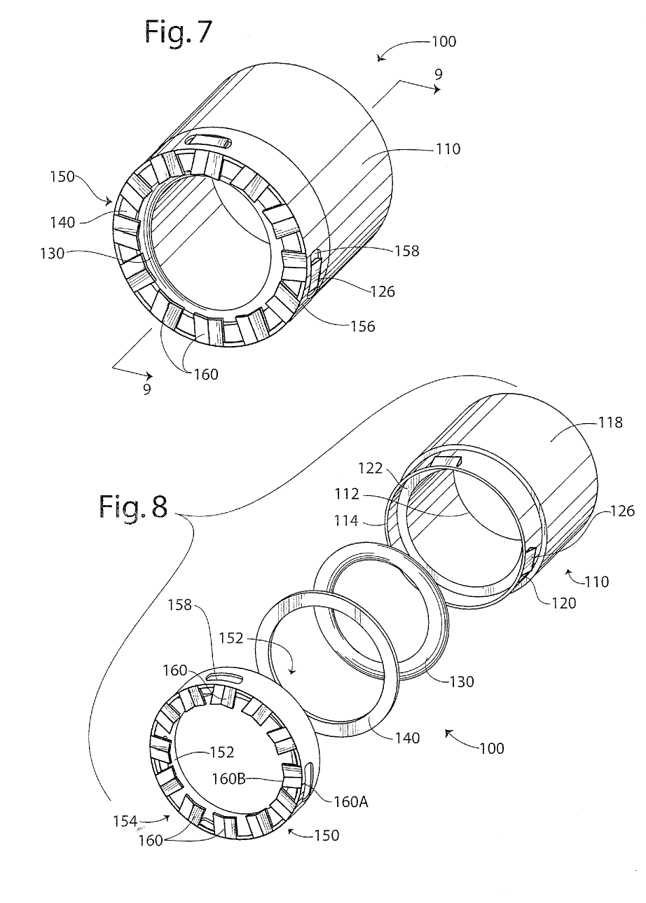

The gripper member 150 may be used with any suitable plumbing component(s) or connection assemblies, for example, in place of known or conventional gripper rings. Plumbing connection assemblies that may incorporate the gripper member 150 may include, for example, tubing connection adapters, fittings and valves. Accordingly, it will be appreciated that plumbing assemblies according to embodiments of the present invention are not limited to those described hereinafter with reference to FIGS. 7-14.

With reference to FIG. 6, a gripper member 250 according to further embodiments of the present invention is shown therein. The gripper member 250 may be used in place of the gripper member 150. The gripper member 250 has a base 256 and teeth 260 and is formed and configured in the same manner as the gripper member 150 except that each tooth 260 has a lengthwise bend 264 that provides the terminal edge 262 of the tooth 260 with a substantially inverted V-shaped profile. The V-shaped profile is oriented such that the outer ends of the “V” are positioned radially inward relative to the apex of the “V”. Outer end sections or points 265A of the tooth 260 are thus located radially inwardly of an apex section or point 265B of the tooth 260. The outer sections 265A collectively define the inner engagement circumference of the gripper member 250.

The gripper member 250 may be used and operate in the same or similar manner to the gripper member 150, except that, when the teeth 260 engage the outer surface of the tubing, the outer end sections 265A initially and preferentially bite into the tubing at spaced apart locations rather than the apex sections 265B.

With reference to FIGS. 7-12, a transition fitting, bushing or adapter 100 according to embodiments of the present invention is shown therein and includes the gripper member 150. The adapter 100 may be constructed, formed and used in the manners disclosed in U.S. patent application Ser. No. 11/867,402, filed Oct. 04, 2007, the disclosure of which is incorporated herein by reference, except that the gripper member or gripper ring disclosed in said patent application would be replaced with the gripper member 150 (as shown) or 250.

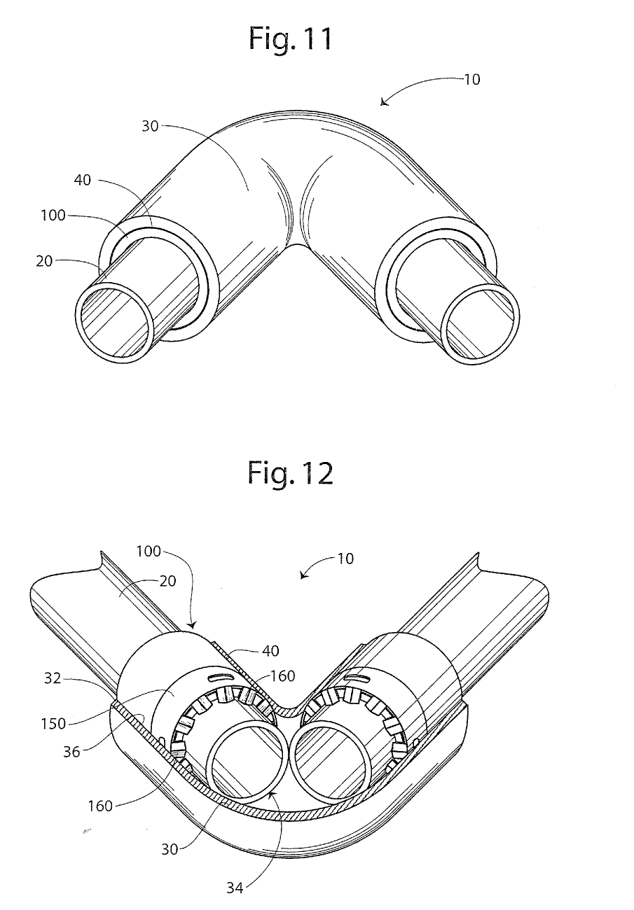

According to some embodiments, the adapter 100 is used to effectively and operatively couple a non-solvent weldable tubing to a solvent weldable tubing or fixture. For example, with reference to FIGS. 11 and 12, the adapter 100 may be used to join a non-solvent weldable tubing 20 to a solvent weldable member 30 using a solvent weld material to form a connection assembly 10. The adapter 100 may be installed and the connection 10 may be assembled using a tool as described in U.S. patent application Ser. No. 11/867,402, filed Oct. 04, 2007, the disclosure of which is incorporated herein by reference.

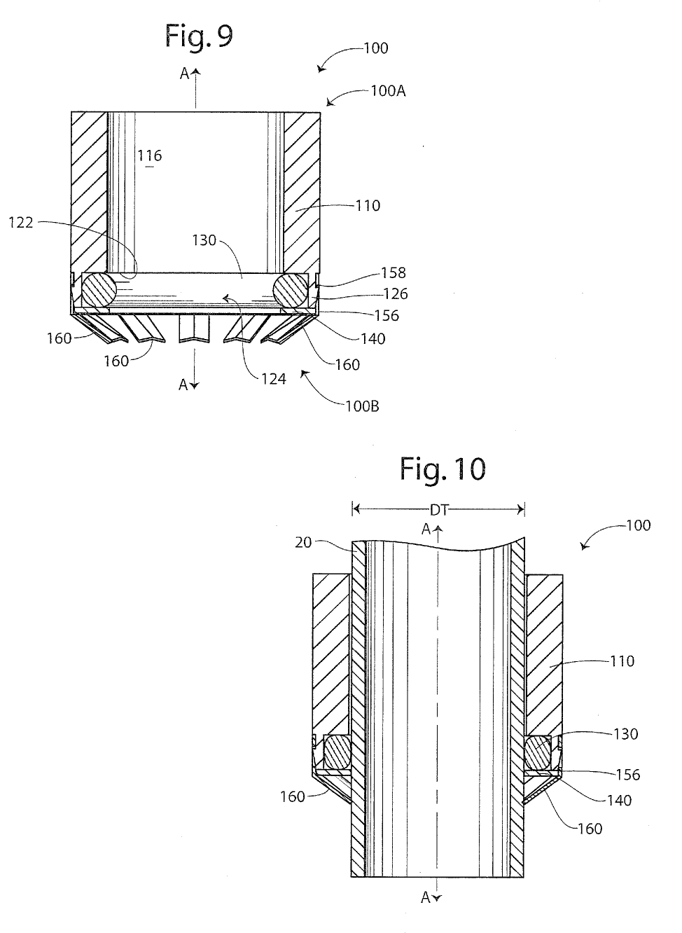

Turning to the adapter 100 in more detail, the adapter 100 has a first end 100A (referred to herein as the entrance end) and a second end 100B (referred to herein as the exit end) (FIG. 9). The adapter 100 includes an annular body member 110, an annular seal member 130, an annular support spacer 140, and the annular gripper member 150.

With reference to FIGS. 8 and 9, the body 110 includes a cylindrical main section 118 and an annular end flange 120 defining an entry opening 112, an exit opening 114, and a through passage 116 extending from the entry opening 112 to the exit opening 114. A ledge 122 is located between the main section 118 and the flange 120. The ledge 122 and the flange 120 together define a recess or pocket groove 124. Four circumferentially spaced apart mounting tabs 126 extend radially outwardly from the flange 120. The body 110 defines a central insertion axis coextensive with the axis A-A extending through the openings 112, 114 and the passage 116.

The body member 110 may be formed of any suitable solvent weldable plastic or polymeric material. According to some embodiments, the body member 110 is formed of PVC and/or CPVC.

The seal member 130 may be formed of any suitable sealing material. According to some embodiments, the seal member 130 is formed of an elastomeric material. According to some embodiments, the seal member 130 is formed of synthetic elastomer. According to some embodiments and as shown, the seal member 130 is an O-ring. According to some embodiments, the seal member 130 is elastically deformable and has an inner diameter less than the outer diameter DT of the tubing 20. According to some embodiments, the inner diameter of the seal member 130 is between about 0.010 and 0.016 inch less than the outer diameter DT of the tubing 20. According to some embodiments, the inner diameter of the seal member 130 is between about 0.609 and 0.615 inch.

The spacer 140 (FIG. 8) may be formed of any suitably rigid material. According to some embodiments, the spacer 140 is formed of a liquid impermeable, corrosion resistant material. According to some embodiments, the spacer 140 is formed of a polymeric material. According to some embodiments, the spacer 140 is formed of metal such as stamped stainless steel. According to some embodiments, the inner diameter of the spacer 140 is greater than the outer diameter DT of the tubing 20. According to some embodiments, the inner diameter of the spacer 140 is between about 0.011 and 0.021 inch greater than the outer diameter of the tubing 20. According to some embodiments, the inner diameter of the spacer 140 is in the range of from about 0.636 to 0.646 inch. According to some embodiments, the thickness of the spacer 140 is in the range of from about 0.020 to 0.040 inch.

The adapter 100 is configured or assembled as follows. The seal member 130 is received in the pocket groove 124 of the body 110. The support spacer 140 is placed over the seal member 130. The gripper member 150 is in turn pressed or mounted over the end of the body 110 so that the seal member 130 and the spacer 140 are captured between the gripper member 150 and a ledge 122 of the body 110. The gripper member 150 is secured to the body 110 by interlock between the tabs 126 of the body 110 and the slots 158. The spacer 140 seats in the gripper member 150 such that the spacer 140 abuts the bases of the teeth 160. The spacer 140 may be biased against the teeth 160 by the seal member 130. The spacer 140 may serve to protect the seal member 130 from the gripper member 150 during assembly of the adapter 100. The spacer 140 may also serve to assist in inhibiting or preventing withdrawal of the tubing 20 from the adapter 100.

The tubing 20 may be any suitable non-solvent weldable plastic or polymeric tubing. According to some embodiments, the tubing 20 is formed of a high temperature polyolefin. According to some embodiments, the tubing 20 is formed of polybutylene, polyethylene, PEX, and/or polyethylene-raised temperature (PE-RT).

The solvent weldable member 30 may be formed of any suitable solvent weldable plastic or polymeric material. Suitable materials may include PVC and/or CPVC. The solvent weldable member may be of any suitable configuration. According to some embodiments, the solvent weldable member 30 is a solvent weldable fitting (such as a tubular fitting as shown) or solvent weldable tubing. According to some embodiments and with reference to FIG. 12, the solvent weldable member 30 has an opening 32 communicating with a passage 34, and an inner surface 36 along the passage 34.

The adapter 100 may be used as follows to form the connection 10. The tubing 20 is inserted into and through the adapter 100. As discussed above, the gripper member 150 provides a mechanical interlock between the adapter 100 and the tubing 20 to permanently prevent withdrawal of the tubing 20 from the adapter 100 in the reverse direction beyond the seal member 130.

With the adapter 100 installed on the tubing 20, the weld solvent is applied to the outer surface 111 of the body member 110 and to the inner surface 36 of the fitting 30. The weld solvent is adapted to temporarily soften the material of each component so that the components melt, intermingled, and re-solidify into an integral, welded unit. The weld solvent may be any suitable weld solvent adapted to chemically weld two solvent weldable polymeric components. According to some embodiments, the weld solvent is a blend of solvents. Suitable weld solvents may include, for example, tetrahydrofuran and cyclohexanone.

The adapter 100 (with the tubing 20 installed therein) is then inserted into the passage 34 of the fitting 30 through the opening 32 until the entrance end 100A of the body 110 is approximately flush with the opening 32 as shown in FIGS. 11 and 12. The weld solvent will then weld the body member 110 to the fitting 30 as described above to form a secure weld 40 (FIG. 12).

The adapter 100 thus takes advantage of the geometrical configuration of the assembly, and in particular of the teeth 160 and the tubing 20, to ensure a secure hold. The longitudinal bends 164 in the teeth 160 may serve to preserve this geometrical advantage by preventing the teeth 160 from deflecting toward the entrance end 100A beyond 90 degrees (with respect to the tubing insertion axis). The bends 164 thereby function to prevent the teeth 160 from inverting (which, if permitted, may release the bite of the teeth 160 on the tubing 20 and permit withdrawal of the tubing 20). This may ensure that the mechanical coupling between the tubing 20 and the adapter 100 (in particular, the gripper member 150) is effectively permanent in service. The teeth 160 configured as described herein can therefore permit the use of a thinner and/or more flexible material for the gripper member 150. The spacer 140 may serve to protect the seal member 130 from the sharp edges of the teeth 160.

In the foregoing manner, the adapter 100 and method can provide a connection 10 that is sufficiently permanent that it can meet existing code requirements for non-accessible fitting joints and therefore can be utilized behind walls and in enclosed spaces without requiring special market preparation and/or code acceptance procedures. According to some embodiments, the adapter 100 is factory assembled.

Because the seal member 130 is mounted upstream or inboard of the gripper member 150, the installer is guaranteed that the tubing 20 has passed fully through the seal member 130 if the tubing 20 engages the teeth 160.

According to some embodiments, the adapter 100 and the connection 10 form a part of a hot and cold water supply system. According to some embodiments, the adapter 100 and the connection 10 form a part of a radiant heating system including a network or loop of tubing through which hot fluid is circulated.

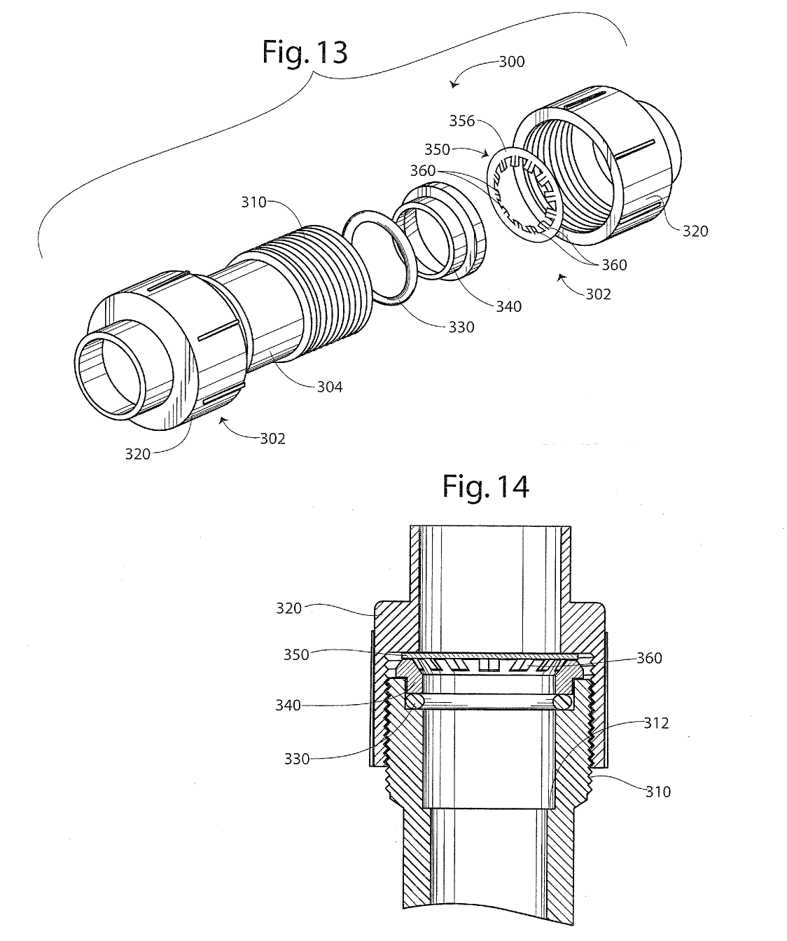

With reference to FIGS. 13 and 14, a plumbing component assembly 300 according to further embodiments of the present invention and incorporating a gripper member 350 is shown therein. The gripper member 350 may be identical or similar to the gripper member 150 or 250, except that the base section 356 is configured as a flat annular band rather than as a cylindrical collar. The gripper member 350 has teeth 360 configured in the same manner as the teeth 160.

The plumbing component assembly 300 may be referred to as a universal fitting. The fitting 300 includes two subassemblies 302 that are integrally joined by a tubing section 304. The two subassemblies may be identically formed and therefore only one of the subassemblies 304 will be described hereinafter, it being appreciated that said description likewise applies to the other subassembly 304.

The subassembly 304 includes an externally threaded tubular base 310 and an annular internally threaded cap or nut 320 screwed onto the base 310. An O-ring seal 330, a body spacer 340, and the gripper member 350 are nested in the base 310 between the base 310 and the nut 320 as shown. The O-ring 330 is interposed or sandwiched between the spacer 340 and a flange 312. The gripper member 150 is interposed or sandwiched between the spacer 340 and the nut 320.

In use, tubing is inserted into the subassembly such that the gripper member 350 interlocks with the tubing as discussed herein. The O-ring 330 forms a fluid-tight seal about the tubing. A second tubing may be installed in the opposing subassembly 304.

While particular dimensions are indicated on the figures, these dimensions are merely exemplary and adapters according to embodiments of the present invention may be formed in various sizes.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

What is claimed is:

1. A gripper member for forming a connection with tubing, the gripper member comprising:
an annular ring body; and
a plurality of teeth extending from the ring body, wherein each tooth has a tooth length and a fixed end and an opposed free end spaced apart along the tooth length, wherein the fixed end adjoins the ring body;
wherein the teeth are angled radially inwardly from the ring body such that the free ends define an inner engagement circumference to receive the tubing; and
wherein each tooth has a substantially creased lengthwise bend formed therein.

2. The gripper member of claim 1 wherein:
each tooth has a terminal edge on its free end; and
each tooth is configured such that, when the tubing is inserted through the inner engagement circumference, at least one discrete portion of the tooth's terminal edge engages and bites into the tubing to a substantially greater extent than at least one remaining portion of the tooth's terminal edge.

3. The gripper member of claim 2 wherein the terminal edge of each tooth has a V-shaped profile.

4. The gripper member of claim 3 wherein the outer points of the V-shaped profiles of the teeth define the inner engagement circumference and bite into the tubing when the tubing is inserted through the inner engagement circumference.

5. The gripper member of claim 3 wherein the apex points of the V-shaped profiles of the teeth define the inner engagement circumference and bite into the tubing when the tubing is inserted through the inner engagement circumference.

6. The gripper member of claim 2 wherein the terminal edge of each tooth defines a terminal edge plane and substantially all of the terminal edge lies in the terminal edge plane.

7. The gripper member of claim 6 wherein the lengthwise bend of each tooth extends along a bend axis and the bend axis is substantially orthogonal to the terminal edge plane.

8. The gripper member of claim 1 wherein the lengthwise bend of each tooth extends from the fixed end thereof to the free end thereof.

9. The gripper member of claim 1 wherein the lengthwise bend in each tooth forms an angle of between about 130 and 170 degrees.

10. The gripper member of claim 1 wherein each tooth has a width perpendicular to its length, and the lengthwise bend in each tooth extends across no more than 30% of the width of the tooth.

11. The gripper member of claim 1 wherein the gripper member is formed of metal.

12. The gripper member of claim 1 wherein the teeth are integrally formed with the ring body.

13. The gripper member of claim 1 wherein the teeth are circumferentially spaced apart from one another about the ring body.

14. A plumbing connection assembly for forming a connection with tubing, the assembly comprising:
a plumbing component body; and
a gripper member mounted on the plumbing component body, the gripper member comprising:
an annular ring body; and
a plurality of teeth extending from the ring body, wherein each tooth has a tooth length and a fixed end and an opposed free end spaced apart along the tooth length, wherein the fixed end adjoins the ring body;
wherein the teeth are angled radially inwardly from the ring body such that the free ends define an inner engagement circumference to receive the tubing; and
wherein each tooth has a substantially creased lengthwise bend formed therein.

15. The assembly of claim 14 wherein the assembly includes an adapter for forming a connection between a non-solvent weldable tubing and a solvent weldable member, wherein the plumbing component body is solvent weldable and the assembly further includes a resilient seal member configured to engage and form a fluid-tight seal between the non-solvent weldable tubing and the plumbing component body.

16. A method for forming a gripper member adapted to form a connection with tubing, the method comprising:
forming an annular ring body;
forming a plurality of teeth extending from the ring body, wherein each tooth has a tooth length and a fixed end and an opposed free end spaced apart along the tooth length, wherein the fixed end adjoins the ring body;
angling the teeth radially inwardly from the ring body such that the free ends define an inner engagement circumference to receive the tubing; and
bending each tooth to form in the tooth a substantially creased lengthwise bend.

17. A gripper member for forming a connection with tubing, the gripper member comprising:
an annular ring body; and
a plurality of teeth extending from the ring body, wherein each tooth has a tooth length and a fixed end and an opposed free end spaced apart along the tooth length, wherein the fixed end adjoins the ring body and a terminal edge is located on the free end;
wherein the teeth are angled radially inwardly from the ring body such that the free ends define an inner engagement circumference to receive the tubing;
wherein each tooth has a lengthwise bend formed therein; and
wherein each tooth is configured such that, when the tubing is inserted through the inner engagement circumference, at least one discrete portion of the tooth's terminal edge engages and bites into the tubing to a substantially greater extent than at least one remaining portion of the tooth's terminal edge.

18. A plumbing connection assembly for forming a connection with tubing, the assembly comprising:
a plumbing component body; and
a gripper member mounted on the plumbing component body, the gripper member comprising:
an annular ring body; and
a plurality of teeth extending from the ring body, wherein each tooth has a tooth length and a fixed end and an opposed free end spaced apart along the tooth length, wherein the fixed end adjoins the ring body and a terminal edge is located on the free end;
wherein the teeth are angled radially inwardly from the ring body such that the free ends define an inner engagement circumference to receive the tubing;
wherein each tooth has a lengthwise bend formed therein; and
wherein each tooth is configured such that, when the tubing is inserted through the inner engagement circumference, at least one discrete portion of the tooth's terminal edge engages and bites into the tubing to a substantially greater extent than at least one remaining portion of the tooth's terminal edge.

19. The assembly of claim 18 wherein the assembly includes an adapter for forming a connection between a non-solvent weldable tubing and a solvent weldable member, wherein the plumbing component body is solvent weldable and the assembly further includes a resilient seal member configured to engage and form a fluid-tight seal between the non-solvent weldable tubing and the plumbing component body.

20. A method for forming a gripper member adapted to form a connection with tubing, the method comprising:
forming an annular ring body;
forming a plurality of teeth extending from the ring body, wherein each tooth has a tooth length and a fixed end and an opposed free end spaced apart along the tooth length, wherein the fixed end adjoins the ring body and a terminal edge is located on the free end;
angling the teeth radially inwardly from the ring body such that the free ends define an inner engagement circumference to receive the tubing;
bending each tooth to form in the tooth a lengthwise bend; and
configuring each tooth such that, when the tubing is inserted into the inner engagement circumference, at least one discrete portion of the tooth's terminal edge engages and bites into the tubing to a substantially greater extent than at least one remaining portion of the tooth's terminal edge.
